(19) United States
(12) Patent Application Publication
(10) Pub. No.: US 2012/0073447 A1
(43) Pub. Date: Mar. 29, 2012

(54) ESPRESSO COFFEE MACHINE

(76) Inventor: Pablo Gonzalez Cid, Mexico City (MX)

(21) Appl. No.: 13/102,800

(22) Filed: May 6, 2011

(30) Foreign Application Priority Data
Sep. 29, 2010 (MX) MX/A/2010/0170723

(51) Int. Cl. A47J 31/44

(52) U.S. Cl. 99/280; 99/281

(57) ABSTRACT

It is disclosed an espresso coffee machine, which comprises a temperature regulation system that includes a water storage vessel, in direct flow connection with a water heater of thermoblock type. The water heater of thermoblock type is at a first warming temperature and contains inside a coil through which the water flows at room temperature coming from the water storage vessel. When the water flows at room temperature through the coil the temperature is raised up to an initial warming temperature, producing steam in this way, to reduce later its temperature from the initial warming temperature up to the final extraction temperature. Said temperature regulation system includes besides a temperature sensor which measures the temperature inside the water heater of thermoblock type; an outlet or relief valve disposed between the water heater or thermoblock type and the water/steam vessel which releases the very hot water and/or the water steam obtained from the thermoblock when the water is at an initial warming temperature; an electronic controller or electronic card disposed behind the thermoblock and whose function is to allow that the temperature sensor measures the temperature inside the water heater and allow that the outlet or relief valve changes from a closed position to an opened position and vice versa, and a water/steam collector vessel which receives the water and/or steam coming from the water heater when the outlet or relief valve is in an opened position.

### FIELD OF THE INVENTION

This invention is related to the techniques employed in the design and manufacturing of coffeepots, and more particularly it is related to an espresso coffee machine which comprises a regulation system for the water temperature for the obtention of an espresso coffee with an ideal temperature and optimal quality.

### BACKGROUND OF THE INVENTION

It is known that one of the main problems in the preparation of coffee, and more particularly, in the preparation of espresso coffee in heating systems based on thermoblocks, is the regulation of the thermoblock temperature within the coffeepot, and in this way being able to obtain a coffee of optimal quality, which provides a better taste of the coffee and the perfect extraction without burning the coffee.

With the course of time, there have been made different heating means in the coffeepots to be able to obtain the water at an optimal temperature desired for the preparation of espresso coffee. These heating means can consist of heaters, heat exchangers, thermoblocks boilers, etc. However, one of the difficulties that these heating means have to address is that due to the variations in the temperature presented when the water comes out from the same towards the coffee grains, it is difficult that the water be at the desired temperature which is required to obtain a coffee with optimal quality and taste.

This is why there have been included different ways to regulate the temperature in these coffeepots, so that by the moment of preparation of the espresso coffee, this does not be burnt. In the previous art, some ways to regulate the water temperature mention the use of pumps that make flow water from one heater through a header, however, said coffeepots have a slow response for the preparation of coffee. Other ways to control the water temperature mention increasing the water temperature in a heater to increase the heat transference in the water flowing through a heat exchanger, however as the residual time of the water within the heat exchanger is not enough to obtain the increment of the temperature in the heat exchanger, so this is not an optimal solution.

An example of the temperature regulation can be seen in the Patent U.S. Pat. No. 4,551,611, where is disclosed an espresso coffee machine to prepare espresso coffee, which is provided with a heater of electrical resistance which has a temperature transducer of a type which comprises a negative temperature coefficient, which in turn produces a signal that indicates the temperature of the heater. A comparing unit is fed from the leaving signal and compares this signal with extreme values of a temperature range to control the activation and deactivation of a heater. This type of control have the drawback that besides of being expensive, the time of water regulation is greater and the temperature variation within the heater are significant, obtaining in this way or a burnt coffee or a too hot or cold coffee.

Commonly, the heaters of thermoblock type are preferably used to heat the water in the espresso coffee machines, because they are not expensive and can produce an espresso coffee of an average quality, and in some instances certain coffeepots can produce enough steam to make foam in the milk for the preparation of “cappuccino” coffee, just as it is mentioned in patents CH 593 044, FR 2 799 630 and ES 2 244 478. However, these thermoblock heaters are very unstable regarding the temperature variation that can be suffered by the water passing through them, being them constituted of a material with a high thermal capacity, they can accumulate importantly calorific energy and high thermal conductivity for the transference of the required quantity of heat accumulated towards the liquid that is circulating through them, and then the water can be too hot and generate steam, which will come out together with the extraction of coffee, hindering in this ways, that the coffee be obtained in optimal conditions, or to the contrary, if when trying to control the thermoblock temperature, this has an important drop, then the water will be below the ideal temperature for the obtention of a good extraction of the coffee.

For all these drawbacks, there exists actually the need of having a system that can regulate successfully the water temperature within the coffeepot, without the need of incorporating to said coffeepot sophisticated and expensive electrical circuits and that besides, the preparation time between each coffee be reduced.

### SUMMARY OF THE INVENTION

Due to the above, we have searched to suppress in a practical, simple and economical way the drawbacks presented by the temperature regulations systems within the coffeepots found in the previous art, by means of the incorporation of a system to a coffeepot for the preparation of espresso coffee which allows to obtain an espresso coffee of quality and optimal taste.

Therefore, it is an object of this invention to provide a coffeepot, and more particularly, and espresso coffee machine for the preparation of espresso coffee which incorporates in a simple and economical way a water temperature regulation system for the obtention of an espresso coffee of optimal quality and taste.

Another object of this invention, is to have a lesser waiting time in the stabilization of the temperatures for the preparation of an espresso coffee and another object is, not having to wait that the water be chill or heat in order to be able to prepare the espresso coffee.

To comply these objectives, we have developed a coffeepot that consists of a water storage vessel in a direct flow connection with the water heater, being said water heater at a first warming temperature, and which contains inside a duct in a form of a coil for which the water passes at room temperature coming from storage vessel, the water raises its temperature up to the initial heating temperature when passing by the duct, producing in this way steam for reducing later its temperature from the initial heating temperature of the water up to a final extraction temperature, in addition, the coffeepot includes a temperature sensor in the water heater, an outlet or relief valve disposed in the water heater and a collector vessel of water/steam, an electronic card and a collector vessel of water/steam where are collected the water and/or the steam that comes out from the water heater.

### BRIEF DESCRIPTION OF THE DRAWINGS

The novel aspects that are considered as characteristics of this invention will be established particularly in the attached claims. However, this invention will be disclosed below, referring to the attached drawings, in which:

FIG. 1 is a schematic representation of an espresso coffee machine according to this invention.

FIG. 2 is a perspective view of inside the coffeepot, according to a preferred embodiment of this invention.

FIG. 3 is a side view of the coffeepot of FIG. 1 where there has been removed a portion of the shell in order to appreciate the inside of the same.

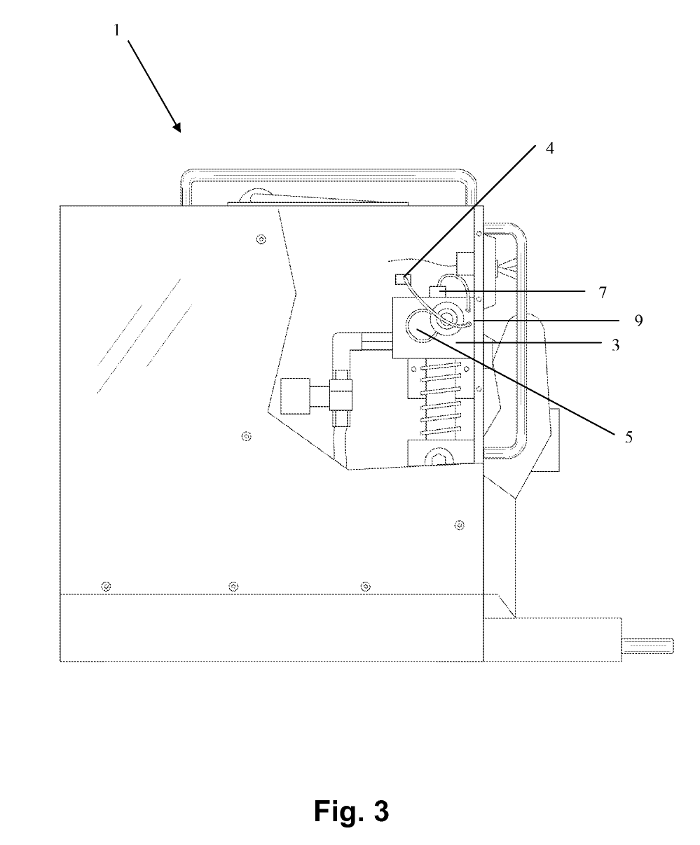

### DETAILED DESCRIPTION OF THE PREFERRED EMBODIMENT OF THE INVENTION

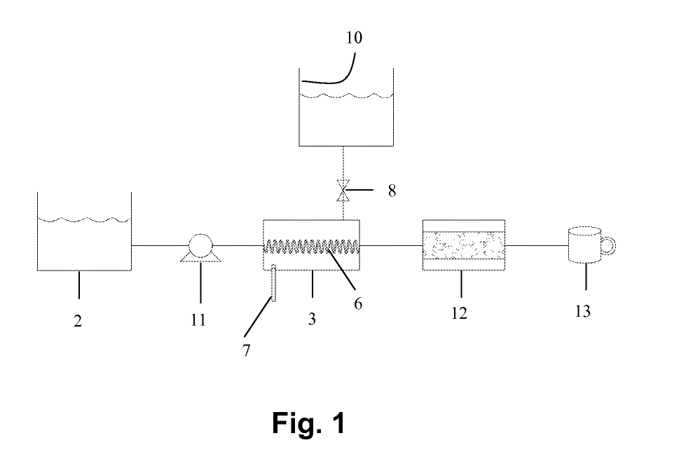

FIG. 1 shows schematically the performance of the temperature regulation for an espresso coffee machine which is disclosed with more detail below. It is placed water at room temperature in a water storage vessel (2), the espresso coffee machine is turned on and by the moment of making the extraction of the coffee the pump (11) which makes flow the water at room temperature from the water storage vessel (2) through the duct in the form of a coil (6) which is inside of a water heater of thermoblock type (3).

The water heater of thermoblock type (3) is at a first warming temperature in the range from 95° C. to 114° C. At the same time the pump (11) and the temperature sensor (7) are activated, measuring the sensor the temperature within the water heater of the thermoblock type (3). When the water at room temperature flows through the duct in the coil shape (6), the water raises its temperature up to the initial warming temperature that is greater than the water boiling temperature, producing by this reason steam and water with a high temperature.

When the temperature sensor (7) measures a temperature higher than 100° C., the outlet or relief valve (8) changes the position from a closed position to an open position, allowing that the water and/or the steam that are within the duct in a coil shape (6) coming out through said outlet or relief valve (8) and towards the water/steam collector vessel (10). In this way, more water flows from the water storage vessel (2) towards the duct of coil shape (6) to reduce the temperature and reach a final extraction temperature that is within the range from 97° C. to 99.99° C., that is an ideal temperature for the preparation of espresso coffee. Reaching said extraction temperature, the outlet or relief valve (8) changes to a closed position allowing the water flow from the water heater of thermoblock type (3) towards the coffee grains (12) and so obtaining the espresso coffee (13) of an optimal quality and ideal temperature.

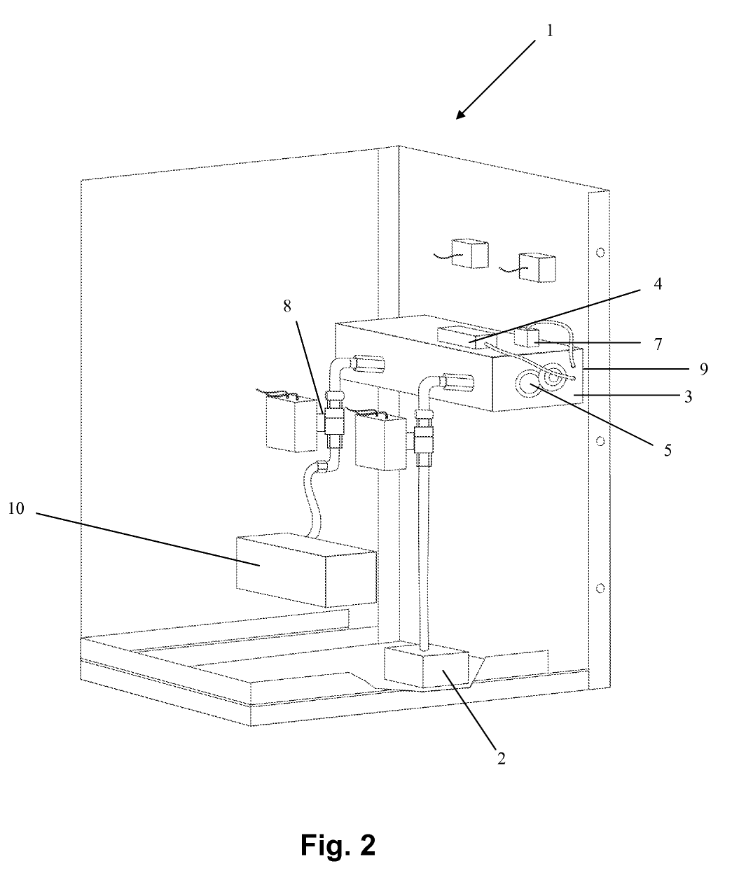

Based on the above, we now refer to FIGS. 2 and 5, where there is shown an embodiment of the coffeepot (1) which comprises a temperature regulation system which includes a water storage vessel (2) which contains water at room temperature, being said water storage vessel (2) in a direct flow connection with the water heater of thermoblock type (3), that includes a safety thermostat (4) placed in the upper part of same and a heat resistance (5) to heat said thermoblock (3). The water heater of thermoblock type (3) is at a first warming temperature which is within a range from 95° C. to 114° C. and contains inside, a coil shaped duct (6) flowing by it the water at room temperature coming from the water storage vessel (2).

When the water at room temperature flows by the duct, it's temperature is raised up to an initial heating temperature that is greater than 100° C., producing in this way steam being the water at a temperature that is higher to its boiling temperature, to produce later the temperature from said initial warming temperature up to a final extraction temperature that is within a range from 97° C. to 99.99° C.

Said temperature regulation system, besides includes, a temperature sensor (7) which measures the temperature inside the water heater of thermoblock type (3); an outlet or relief valve (8) disposed between the water heater of thermoblock type (3) and the water/steam obtained from the thermoblock (3) when the water is at an initial warming temperature; an electronic controller or electronic card (9) disposed behind that thermoblock and whose function is to allow that the temperature sensor (7) measures the temperature inside the water heater (3) and allow outlet or relief valve (8) change from a closed position to an opened position and vice versa; and a water/steam collector vessel (10) which receives the water and/or steam coming from the water heater (3) when the outlet or relief valve (8) is in an opened position.

Now, pursuant what is disclosed and illustrated above in the attached drawings, it can be appreciated that the temperature regulation system for an espresso coffee machine, has such a performance, that the temperature regulation inside the water heater of thermoblock type is obtained only with water flow through the coil shaped duct, reason why it is suppressed the need of waiting until the water is cold or hot for the preparation of consecutive cups of coffee, reducing in this way the waiting time between preparation and preparation.

In this way, it will be evident for any person skilled in the art, that the formerly disclosed embodiments are only illustrative but they are not limiting this invention, since there are possible numerous modifications of consideration in its details, as can be the configuration of the temperature regulation system inside the coffeepot, the size of same, or some other modifications, but without being moving away from the real scope of the invention.

Therefore, this invention must not be restrained except for what is set forth, in the state of the art and by the spirit of the attached claims.

1. An espresso coffee machine, which comprises a temperature regulation system, which includes:
a) a water storage vessel;
b) a water heater in flow connection with the storage vessel, the heater is at a first warming temperature and that has inside a duct for which at the moment of the extraction of coffee, the water flows from the storage vessel, raising the water temperature up to an initial heating temperature, producing steam and/or water reducing later its temperature up to a final extraction temperature;
c) a temperature sensor to measure the temperature inside the water heater;
d) an outlet or relief valve in a flow connection with the water heater to release the water and/or water steam inside the water heater when the water is at the warming temperature; and
e) a controller operatively connected to the temperature sensor and the outlet or relief valve, so that it changes from a closed position to an opened position and vice versa;
f) a water/steam collector vessel which receives the water and/or the steam coming from the water heater.

2. The espresso coffee machine according to claim 1, wherein the water inside the storage vessel is at room temperature.

3. The espresso coffee machine according to claim 1, wherein the water heater is of thermoblock type.

4. The espresso coffee machine according to claim 1, wherein the first heating temperature is within the range from 95° C. to 114° C.

5. The espresso coffee machine according to claim 1, wherein the initial warming temperature is higher than 100° C.

6. The espresso coffee machine according to claim 1, wherein the final extraction temperature is within the range from 97° C. to 99.99° C.

7. The espresso coffee machine according to claim 1, wherein the outlet or relief valve changes from the closed position to an opened position when the temperature sensor measures an initial heating temperature.

8. The espresso coffee machine according to claim 7, wherein the outlet or relief valve is in an opened position that allows that the water and/or the steam that is within the coil goes out through said valve and towards the water/steam collector vessel.

9. The espresso coffee machine according to claim 1 and 6, wherein the outlet and relief valve changes from the opened position to a closed position when the temperature sensor measures a final extraction temperature.

10. The espresso coffee machine according to claim 1 and 9, wherein the outlet and relief valve is in a closed position and the water flows from the water heater towards the coffee grains for the obtention of the espresso coffee.
